(19) United States
(12) Patent Application Publication
(10) Pub. No.: US 2023/0287713 A1
(43) Pub. Date: Sep. 14, 2023

(54) VEHICLE LATCH ASSEMBLY FOR SLIDING DOOR

(71) Applicant: Kason Industries, Inc., Newnan, GA (US)

(72) Inventors: Brett Mitchell, Newnan, GA (US); Jeff Underwood, Newnan, GA (US)

(21) Appl. No.: 17/689,021

(22) Filed: Mar. 8, 2022

(51) Int. Cl. E05B 79/04; E05B 85/02; E05B 79/06

(52) U.S. Cl. CPC E05B 79/04; E05B 79/06; E05B 85/02

(57) ABSTRACT

A vehicle latch assembly for a vehicle sliding door includes an exterior latch, an interior latch, and a variety of spacers of different or differentially distinct widths. The interior latch includes a latch mounting plate or housing The latch housing has four latch mounting holes and two spacer mounting holes. Each spacer has four latch mounting holes and two spacer mounting holes which extend from a countersunk screw head recess. The exterior latch is positioned against the exterior side of the sliding door and four mounting bolts pass through four mounting holes extending through the exterior latch, through four mounting holes in the sliding door, through the four latch mounting holes in the spacer, and through the four latch mounting holes in the interior latch. A mounting nut is threaded onto each mounting bolt and tightened to secure the exterior latch and interior latch in this position.

### TECHNICAL FIELD

This invention relates to vehicle door latches, and particularly to latch assemblies for a vehicle sliding doors.

### BACKGROUND OF INVENTION

Package delivery trucks, which have also been referred to as panel trucks and vans, typically have one or more sliding doors. By gripping a door handle on the inside or outside, the door may be manually moved between positions closing and opening a doorway in the truck body. These doors typically have a latch coupled with the two handles which holds the door in a fully opened or fully closed position by engagement with strikes mounted to the door opening adjacent each end of the door run. The door in its closed position may thus be unlatched and slid open from either side of the door by rotation and pulling of the inside or outside handle.

A common problem with these doors is the proper mounting of the latch to the door itself, as the thickness of the door may vary. If the latch is not properly mounted, the latch will not mate or engage properly with the corresponding strike coupled to the door opening.

Accordingly, it is seen that a need exists for a vehicle door latch which can vary according to the thickness of the vehicle door. It is to the provision of such therefore that exemplary embodiments of the present invention are primarily directed.

### SUMMARY OF INVENTION

A vehicle latch assembly comprises a latch having a housing including a mounting plate adapted to be mounted to a vehicle, and a handle coupled to said housing. The vehicle latch assembly also has a mounting plate spacer selected from a plurality of mounting plate spacers having differentially distinct widths. Each mounting plate spacer has a peripheral configuration corresponding to the peripheral configuration of the mounting plate of the latch housing.

### BRIEF DESCRIPTION OF DRAWINGS

FIG. 1 is a perspective view of a vehicle latch assembly in a preferred form of the invention.

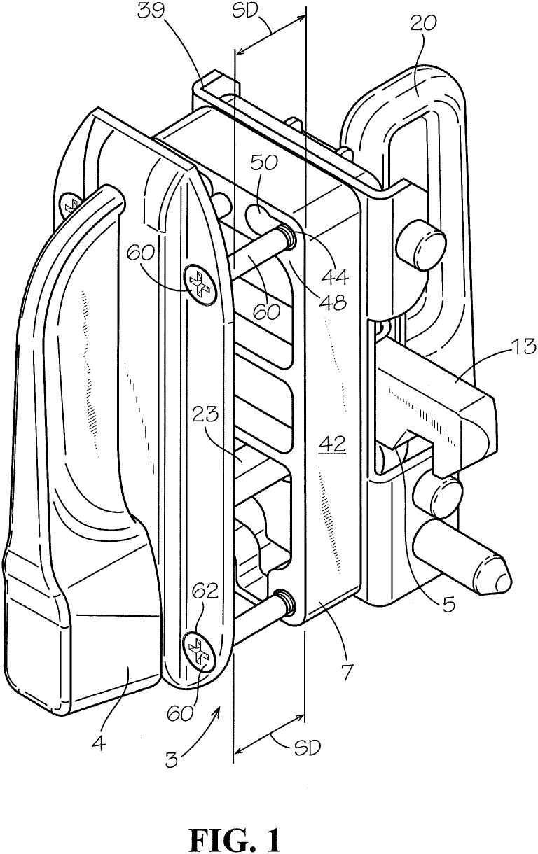

FIG. 2 is an exploded, perspective view of the vehicle latch assembly of FIG. 1.

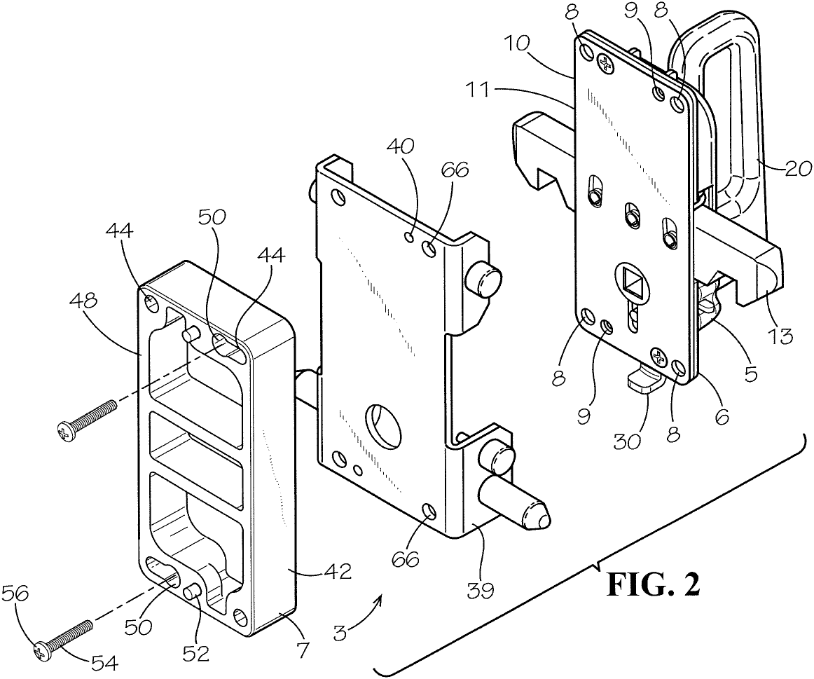

FIG. 3 is a side view of the vehicle latch assembly of FIG. 1.

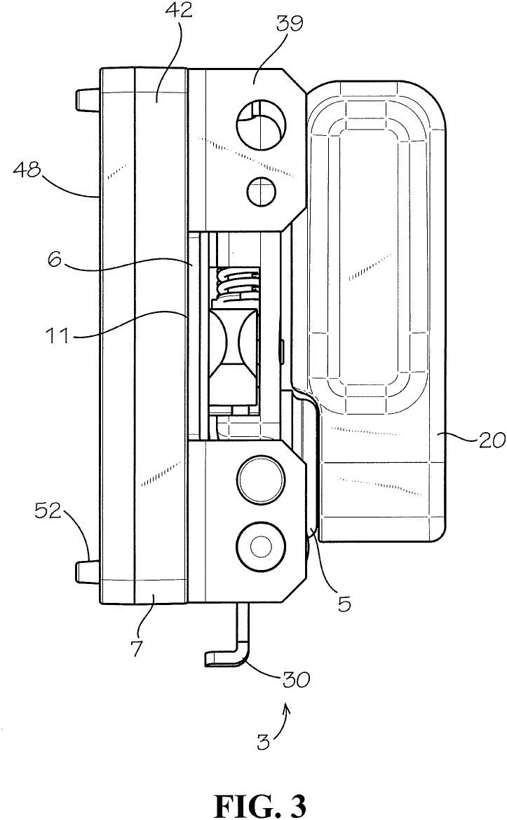

FIG. 4 is a rear view of the vehicle latch assembly of FIG. 1.

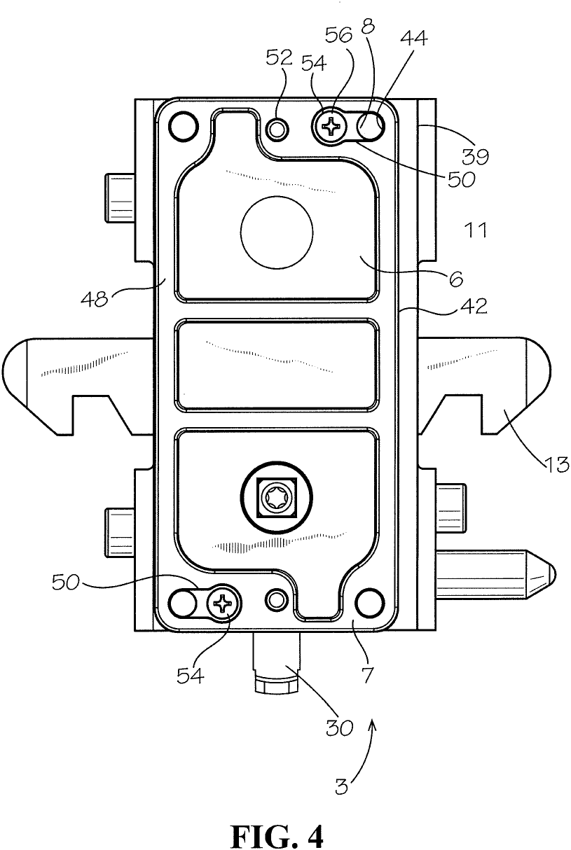

FIG. 5 is a rear view of the spacer of the vehicle latch assembly of FIG. 1.

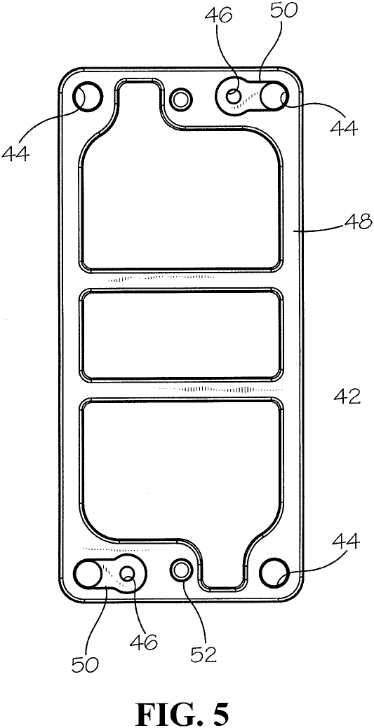

FIG. 6 is a perspective view of two spacers of the vehicle latch assembly of FIG. 1 that show the variations in the width of the spacers.

### DETAILED DESCRIPTION

With reference to the drawings, there is shown a latch assembly 3 for a vehicle sliding door SD embodying principles of the invention in a preferred form. The latch assembly 3 is mounted to the sliding door SD of the vehicle while the unshown lock strikes are mounted to the stationary door jamb portion or doorway of the vehicle.

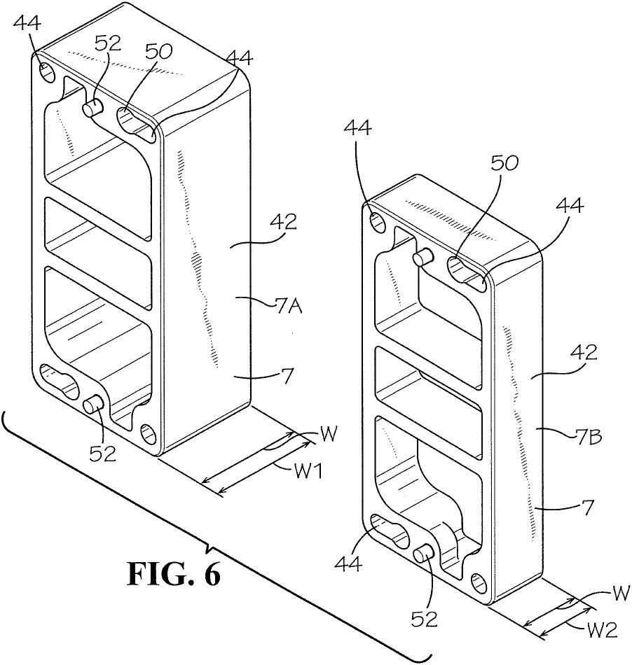

The latch assembly 3 includes an outside or exterior handle 4, an interior latch or latch portion 5, and a spacer 7 selected from a variety of spacers 7 of different or differentially distinct widths or thicknesses. The terms width or thickness in intended to mean the direction generally perpendicular to the surface of the spacer 7 facing the interior latch 5 and is indicated by reference W in FIG. 6. The interior latch 5 and its operation are shown and described in detail in U.S. Pat. Nos. 5,520,423 or 5,979,949, the entire contents of which are commonly owned and incorporated herein by reference. The interior latch 5 may also be one of the models sold under the model designation 4000 series by Kason Industries, Inc. of Shenandoah, Georgia. The exterior handle 4 and inside handle 20 may have different shapes or configurations, and the exterior handle 4 may include or have access to a locking mechanism.

The latch housing 10 has a generally rectangular peripheral shape with a generally planar or flat inboard, rear, or outwardly facing surface 11. The latch housing 10 includes a mounting plate or mounting portion 6 that has four latch mounting holes 8 extending through the mounting plate 6 of the latch housing 10. The mounting plate 6 also has two diagonally opposed internally threaded spacer mounting holes 9 extending through the mounting plate 6 of the latch housing 10. The interior latch includes two catches 13 adjacent its two opposite ends. The unshown latch strikes are mounted to both sides of the track on which a sliding door equipped with the latch assembly 3 is mounted to run.

The interior latch 5 has an inside handle 20 coupled to the exterior handle 4 through a shaft 23. Each of these handles is provided to lift the latch catch 13 off of a strike in unlatching the door to which it is mounted.

The latch assembly 3 is provided with an optional means for manually locking the latch assembly 3 from the inside or a sliding door to which it is mounted to prevent the door from being unlatched from the outside. This locking feature is provided here by a lock bar or slide 30. The latch assembly 3 may also be built without the lock bar 30.

As shown in FIG. 6, the latch assembly 10 includes a variety of spacers 7 of different widths W, the drawings show two spacers 7, however, there could be many more spacers 7 of different sizes to provide more sizing options. The first spacer 7A is shown to have a width W1 which is greater than the width W2 of the second spacer 7B.

Each spacer 7 has a peripheral side or side edge 42 having a generally rectangular shape corresponding or similar to the generally rectangular shape of the periphery of the mounting plate 6 of the latch housing 10. Each spacer 7 has four latch mounting holes 44 extending through the spacer 7 in the direction of the spacer’s width W. Each spacer 7 also has two, diagonally opposed, spacer mounting holes 46 extending through the spacer 7 in the direction of the spacer’s width W.

Each spacer 7 has a generally even, inboard, rear, or outwardly facing surface 48. However, each spacer mounting hole 46 has a countersunk screw head recess 50, which may be extended to a keyhole shape so as to also encompass a closely adjacent latch mounting hole 44. Each spacer 7 may also include two optional, vertically opposed and outwardly extending guide or alignment pins 52.

One of the spacers 7 is selected from the plurality of spacers 7 and mounted or coupled to the interior latch 5 through two threaded screws or bolts 54 which passes through the screw head recesses 50, through the spacer mounting holes 46 of the spacer 7, and threaded into the spacer mounting holes 9 of the latch housing 10. The mounting screws 54 include screw heads 56. If the optional bracket 39 is utilized, the bracket 39 is positioned between the spacer 7 and the interior latch 5 with the mounting screws 54 also passing through screw mounting holes 40 extending through the bracket 39. If the optional bracket 39 is not utilized, the spacer 7 is mounted directly to the interior latch 5.

In use, the interior latch 5 is manually positioned in what is believed to be the proper mounting position relative to the interior surface of the vehicle door and in alignment with the unshown strike mounted in the doorway of the vehicle. The distance between the vehicle door and interior latch 5 may then be measured to determine the proper size of the spacer 7 to be used in mounting the interior latch 5 to the vehicle door.

With the proper size of the spacer 7 determined, the selected spacer 7 from the plurality of spacers 7 is coupled to the inboard surface 11 of the housing 10. To do so, the spacer 7 is positioned against the inboard surface 11 so that the spacer mounting holes 46 of the spacer 7 are aligned with the spacer mounting holes 9 of the mounting plate 6 of the latch housing 10. The mounting screws 54 are then passed through spacer mounting holes 46 and threaded into spacer mounting holes 9 of the latch housing 10. The mounting screws 54 are threaded until they abut the spacer 7, with the screw heads 56 of the mounting screws 54 residing completely within the confines of the screw head recesses 50 so as not to obstruct or encroach upon the flat outwardly facing surface 48 of the spacer 7.

Once the spacer 7 is coupled to the interior latch 5, the interior latch 5 may be coupled to the interior side of the vehicle door. The exterior handle 4 is positioned against the exterior side of the sliding door and four mounting bolts 60 are passed through four mounting holes 62 extending through the exterior handle 4. The spacer guide pins 52 may be utilized to properly position the outwardly facing surface 48 of the spacer 7 against the interior surface of the sliding door SD. The four mounting bolts 60 also pass through four mounting holes in the sliding door SD, through the four latch mounting holes 44 in the spacer 7, and through the four latch mounting holes 8 in the mounting plate 6 of the interior latch 5. If the optional bracket 39 is utilized, the four mounting bolts 60 also extend through mounting holes 66 in bracket 39. An unshown mounting nut is threaded onto each mounting bolt 60 and tightened to secure the exterior handle 4 and interior latch 5 in this position. Alternatively, latch mounting holes 8 of the latch mounting plate 6 may be threaded to receive the mounting bolts 60.

Through the selection of a spacer 7 from the selection of different width sized spacers 7, the interior latch 5 may be properly positioned to mate with the latch strike mounted to the door jamb of the vehicle.

It should be understood that multiple spacers 7 may be stacked together to provide additional variations or adjustments in total heights. This provides additional options in selecting the proper spacing between the sliding door SD and the interior latch 5. The spacer guide pin 52 may be utilized to align and maintain the mutual alignment of the stacked spacers 7.

It thus is seen that multiple latch spacers of different widths or thicknesses are now provided which overcomes problems associated with latches mounted to vehicle sliding doors of the prior art. While this invention has been described in detail with particular reference to the preferred embodiment thereof, it should be understood that many modifications, additions and deletions, may be made thereto without departure from the spirit and scope of the invention as set forth in the following claims.

1. A vehicle latch assembly comprising,
an interior latch having a housing including a mounting plate adapted to be mounted to a vehicle, and a handle coupled to said housing, and
a mounting plate spacer selected from a plurality of mounting plate spacers having differentially distinct widths, each said mounting plate spacer having a peripheral configuration corresponding to the peripheral configuration of said mounting plate of said latch housing.

2. The vehicle latch assembly of claim 1 further comprising at least one mounting screw coupling said latch to said mounting plate spacer, said mounting screw having a screw head.

3. The vehicle latch assembly of claim 2 wherein said mounting plate spacer includes at least one screw head recess extending to a screw mounting hole, and wherein said screw head of said at least one mounting screw is positioned completely within said screw head recess.

4. The vehicle latch assembly of claim 1 wherein said mounting plate spacer includes as least one outwardly extending guide pin oppositely disposed from said interior latch.

5. The vehicle latch assembly of claim 1 wherein said mounting plate of said interior latch has a plurality of first latch mounting holes, and wherein said mounting plate spacer has a plurality of second latch mounting holes which are alignable with said first latch mounting holes of said mounting plate.

6. The vehicle latch assembly of claim 5 wherein said mounting plate of said interior latch has a plurality of first latch mounting holes, wherein said mounting plate spacer has a plurality of second latch mounting holes which are alignable with said first latch mounting holes of said mounting plate, and wherein each said second latch mounting hole is positioned within one said screw head recess.

7. A vehicle latch assembly comprising,
an interior latch having a housing including a mounting plate adapted to be mounted to a vehicle, and a handle coupled to said housing;
a first mounting plate spacer having a first select thickness, and
a second mounting plate spacer having a second select thickness that is different from said first select thickness of said first mounting plate.

8. The vehicle latch assembly of claim 7 wherein said mounting plate has a first peripheral configuration, and wherein said first mounting plate spacer has a second peripheral configuration similar to said first peripheral configuration.

9. The vehicle latch assembly of claim 7 further comprising at least one mounting screw coupling said latch to said first mounting plate spacer, said mounting screw having a screw head.

10. The vehicle latch assembly of claim 9 wherein said first mounting plate spacer includes at least one first screw head recess extending to a first screw mounting hole, wherein said second mounting plate spacer includes at least one second screw head recess extending to a second screw mounting hole, and wherein said screw head of said at least one mounting screw is positioned completely within said first screw head recess or said second screw head recess.

11. The vehicle latch assembly of claim 1 wherein said first mounting plate spacer includes as least one outwardly extending guide pin oppositely disposed from said interior latch.

12. The vehicle latch assembly of claim 7 wherein said mounting plate of said interior latch has a plurality of first latch mounting holes, wherein said first mounting plate spacer has a plurality of second latch mounting holes which are alignable with said first latch mounting holes of said mounting plate, and wherein said second mounting plate spacer has a plurality of third latch mounting holes which are alignable with said first latch mounting holes of said mounting plate.

13. The vehicle latch assembly of claim 12 wherein said mounting plate of said interior latch has a plurality of first latch mounting holes, wherein said first mounting plate spacer has a plurality of second latch mounting holes which are alignable with said first latch mounting holes of said mounting plate, and wherein each said second latch mounting hole is positioned within one said screw head recess.

14. The vehicle latch assembly of claim 13 wherein said second mounting plate spacer has a plurality of third latch mounting holes which are alignable with said first latch mounting holes of said mounting plate, wherein each said third latch mounting hole is positioned within one said screw head recess.

15. A vehicle latch assembly comprising,
an interior latch having a housing including a mounting plate having a select peripheral configuration and adapted to be mounted to a vehicle, and a handle coupled to said housing, and
a mounting plate spacer having a peripheral configuration corresponding to said peripheral configuration of said mounting plate of said housing.

16. The vehicle latch assembly of claim 15 further comprising at least one mounting screw coupling said interior latch to said mounting plate spacer, said mounting screw having a screw head.

17. The vehicle latch assembly of claim 16 wherein said mounting plate spacer includes at least one screw head recess extending to a screw mounting hole, and wherein said screw head of said at least one mounting screw is positioned completely within said screw head recess.

18. The vehicle latch assembly of claim 15 wherein said mounting plate spacer includes as least one outwardly extending guide pin oppositely disposed from said interior latch.

19. The vehicle latch assembly of claim 15 wherein said mounting plate of said interior latch has a plurality of first latch mounting holes, and wherein said mounting plate spacer has a plurality of second latch mounting holes which are alignable with said first latch mounting holes of said mounting plate.

20. The vehicle latch assembly of claim 19 wherein said mounting plate of said interior latch has a plurality of first latch mounting holes, wherein said mounting plate spacer has a plurality of second latch mounting holes which are alignable with said first latch mounting holes of said mounting plate, and wherein each said second latch mounting hole is positioned within one said screw head recess.
